(19) United States
(12) Patent Application Publication
(10) Pub. No.: US 2007/0234200 A1
(43) Pub. Date: Oct. 4, 2007

(54) Model view controller modeling language

(75) Inventor: Brian Gin Farn, Toronto (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/396,781

(22) Filed: Apr. 3, 2006

(51) Int. Cl. G06F 17/00

(52) U.S. Cl. 715/513

(57) ABSTRACT

A model view controller modeling language as an XML schema for creating and describing documents to be rendered on any server or client. The new modeling language contains distinct model, view, and controller sections as well as sections for header information, and session information. MVCML contains one or more forms where each form specifies a user interface hierarchy. The user interface part types are extensible, and all part types, whether they are contained in a core set or provided as supplied extensions to the core set, are specified and processed identically. The user interface layout mechanism can be specified, and new layout mechanisms can be added and form designers have the ability to explicitly specify which part types and layout mechanisms to use. An action may be associated with more than one user interface event. An extensible set of action types, such as ‘submit’, ‘property to property linking’, or ‘process control logic’ can be specified. Mechanisms exist to link user interface part properties to control logic and model data. Local control logic can be specified in a programming language of choice within the document or can reference external control logic. Part content data can be explicitly defined within the document or can be obtained from an external data source, such as a service data object.

### FIELD OF THE INVENTION

This invention relates generally to the field of markup languages and user interfaces of computer processing software, and in particular, relates to a new XML schema that delivers user interface definitions from application servers to clients across a network.

### BACKGROUND OF THE INVENTION

A markup language is a structured computer programming language that has codes for indicating the structure, layout, and styling of a document such as boldface, italics, paragraphs, placement of graphics within a text file, etc. Widely used markup languages include, inter alia, Standard Generalized Markup Language (SGML, ISO 8879:1986), Extensible Markup Language (XML), and Hypertext Markup Language (HTML). Although XML was designed for ease of implementation and for interoperability with both SGML and HTML, there are differences between SGML and HTML and XML. SGML and XML have a specific vocabulary, i.e., labels for elements and attributes, and a declared syntax but SGML is not well suited for serving, receiving, and processing documents on the World Wide Web (the Web). HTML and XML are both used on the Web but the function of HTML differs from XML: XML is designed to carry and describe data and focuses on what the data IS whereas HTML is designed to display data and focuses on how the data LOOKS. Unlike HTML, moreover, the tags used to mark up XML documents and structure are not predefined and an author may define her/his own tags and document structure. XML is important because it may become the most common tool for all data manipulation and transmission on the Web. XML makes it possible to define data because the parties sending and receiving the data use XML to understand the transmitted data. How? Because the document is written in XML, everyone knows the same interpretation of the data because that interpretation is contained within the data. With XML, a programmer can define data structures, make the data structures independent of the hardware and software of the processing devices, process the data automatically, and define her/his own tags or elements. With XML, however, a programmer cannot define how the data is shown; HTML is used to display the data. Thus, most documents and data transmission may actually use a combination of HTML and XML.

XML documents have markup and content. There are six kinds of markup that can occur in an XML document: elements, entity references, comments, processing instructions, marked sections, and schemas. Elements, also called tags, are the most common form of markup and are indicated by the “less than” < and “greater than” > angled brackets. Attributes are name/value pairs after the element name, for instance, <div class=“preface”> means that the element div has an attribute class with the value preface. An entity reference, another kind of XML markup, allows a programmer to insert an indicator into the document as content. For example, if the document were to include the mathematical expression “5<10” (five is less than ten), there must be some way to use the “less than” bracket in this context, rather than as indicating that 10 is an element as described above. XML allows a programmer to define how these particular entities will be referenced, such as by inserting Unicode characters into the document. Comments typically begin with <!--, then have a literal string, and end with -->. Processing instructions providing information to an application manipulating the data contained in the XML document and are usually indicated as <?nameofprocessinginstruction data?>. Marked sections indicates that character data in the marked section are passed directly to the application without interpretation.

Schemas, formerly called document type declarations (DTDs), allow a document to communicate meta-information, i.e., the sequence and nesting of tags or elements, about the document. Meta-information includes the allowed sequence and nesting of elements or tags, attribute values and their types and defaults, the names of external files that may be referenced and whether or not the external files contain XML, the formats of some non-XML data that may be referenced, and the entities that may be encountered. There are four kinds of declarations in XML: element type declarations, attribute list declarations, entity declarations, and notation declarations.

A schema is the graphical depiction of the data and the tags and document structure for a document on the Web. The current XML schemas of user interface forms on web pages are inflexible because they are fixed and do not allow for an extensible set of user interface element types without major changes to the schema. Some of the current XML schemas have a user interface element type that does not have an extensible set of attributes. Extensible HTML (XHTML) does not have the capability to specify a part layout mechanism or layout parameters, that is, layout information is a part of the user interface element definition. In XHTML, a finite set of layout types is supported but there is usually one implicit layout type and no provision for HTTP session information or security information. The model and controller information in XHTML are user interface widget attributes rather than being separately defined. XML-based User Interface Language (XUL) is a user interface markup for Mozilla browsers that has a predefined set of user interface types, such as >window= but, again, there is no separation between model, view, and controller making the data harder to find and read. Another schema, User Interface Markup Language (UIML), was originally intended to be a server-side technology and renders to a device specific markup on the server before sending it to the client. UIML has a large number of elements many of which are unlikely to be used and a renderer would be unable to fit the document into a device having small memory capacity. The large number of XML descendants of the elements, moreover, degrade performance. UIML does have the flexibility of defining logic in XML but this characteristic is almost irrelevant because controller logic can be defined using an existing programming language. UIML, moreover, does not have the ability to specify a part layout mechanism, i.e., how the parts of the user interface are placed relative to each other or in absolute parameters; nor does UIML have the ability to define properties used only within a particular session.

Still another schema is an “intent based” technology for user interface design, Abstract User Interface Markup Language (AUIML). AUIML represents panels, wizards, property sheets, etc. neutral of the platform. AUIML captures relative positioning information of user interface components defined in the panel definition so that the user interface can be described once and then displayed (rendered) to the user in multiple environments and on various devices. Because AUIML is intent-based, explicit widget types cannot be specified and there are a fixed limited set of user interface attributes. Still another schema, XAML (Extensible Application Markup Language), supports only one layout mechanism and the layout information is specified within the part definition. XAML can be expanded to third parts that are treated differently than the core set of parts defined in the XAML schema.

Thus, there is a need for a flexible and extensible XML schema. These needs are met by and other advantages that will be apparent to one of skill in the art are presented by the schema as described below.

### SUMMARY OF THE INVENTION

Thus, what is presented is a Model View Controller Machine Language (MVCML) schema, comprising at least one mvcml element; zero or one header section having descriptive information about a document to be displayed on a client; zero or one session section having information about the applications using the document; zero or one view section having at least one form of user interface information of how to display the document on a client; zero or one model section having data information about the data to be displayed on the document; and zero or one controller section having action information about how an application is to respond to user interface events rendered by the document. Each section is extensible, i.e., additional properties or elements can be added, without requiring changes to other sections of the schema or other properties or elements. The model section contains information about one or more of the following: data to be displayed on the document, location of data to be displayed. The data may be located on a server or another computer connected to the client. The view section contains one or more of the following: a user interface hierarchy, user interface layout, layout data information, references to data, controller actions. The view section has a form to be rendered on the document, the form may have at least one part, and the part may have an additional part, an event, layoutdata, layout, and a view property. All the elements that have properties, such as actions, layout, layoutdata are extensible, i.e., additional properties can be added, without requiring changes to other sections of the schema or other properties. The controller section may control actions or control responses to actions of the user and/or application using the document.

Yet, another embodiment of the invention is a data communication system including a transmitting data processing device which performs data transmission via a communication network and a receiving data processing device which receives the data transmitted from the transmitting data processing device via the communication network, said transmitting data processing device comprising: a transmitting portion which transmits a MVCML document, and said receiving data processing device comprising: a receiving portion which receives the MVCML document transmitted from the transmitting data processing device; and renders the MVCML document on a user interface of the receiving data processing device.

The invention may also be described as a computer program product, in a computer-readable medium, for encoding a MVCML document in a data processing system. And, again, what is presented is a computer program product stored in a computer-readable medium, for decoding a MVCML document in a data processing device, comprising: instructions for reading a MVCML header of the MVCML document; instructions for reading a MVCML session of the MVCML document; instructions for reading a MVCML view of the MVCML document; instructions for reading a MVCML model of the MVCML document; instructions to obtain data referenced by the MVCML model of the MVCML document; instructions for reading a MVCML controller of the MVCML document, instructions to render the MVCML document on the data processing device, and to respond to any actions of a user in response to rendering the MVCML document on the data processing device. The invention, however, can further best be understood by reviewing the figures below comprising the Drawing of the invention with reference to the detailed description that follows.

### BRIEF DESCRIPTION OF THE DRAWING

FIG. 1 is a simplified block diagram of a data processing network that can be used to render a MVCML document in accordance with an embodiment of the invention.

FIG. 2 is a simplified schematic of the MVCML schema and the elements of the various sections in accordance with an embodiment of the invention. It is suggested that FIG. 2 be printed on the face of the patent.

FIG. 3 is a simplified flow chart of a method by which a data processing device can render a MVCML document in accordance with an embodiment of the invention.

### DETAILED DESCRIPTION OF THE INVENTION

The invention is described with reference to the accompanying drawings; however, the invention may be embodied in many different forms and should not be construed as limited to the embodiments set forth herein. Rather the illustrated embodiments are provided so that this disclosure is thorough and complete, and fully conveys the scope of the invention to those skilled in the art. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment, or an embodiment combining software and hardware aspects all generally referred to herein as a “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program source code for carrying out operations of the present invention are preferably written in the new dialect or schema of XML, but code capable of parsing the documents and interpreting the MVCML schema may be written in an object oriented programming language such as JAVA, SMALLTALK or C++. The program object code may execute entirely on the software developer's computer, partly on the software developer's computer, as a stand-alone software package, partly on the software developer's computer and partly on a remote computer or entirely on the remote computer. In the latter scenario, the remote computer may be connected to the software developer's computer through a local area network (LAN) or a wide area network (WAN), or the connection may be made to an external computer via the Internet using an Internet Service Provider.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

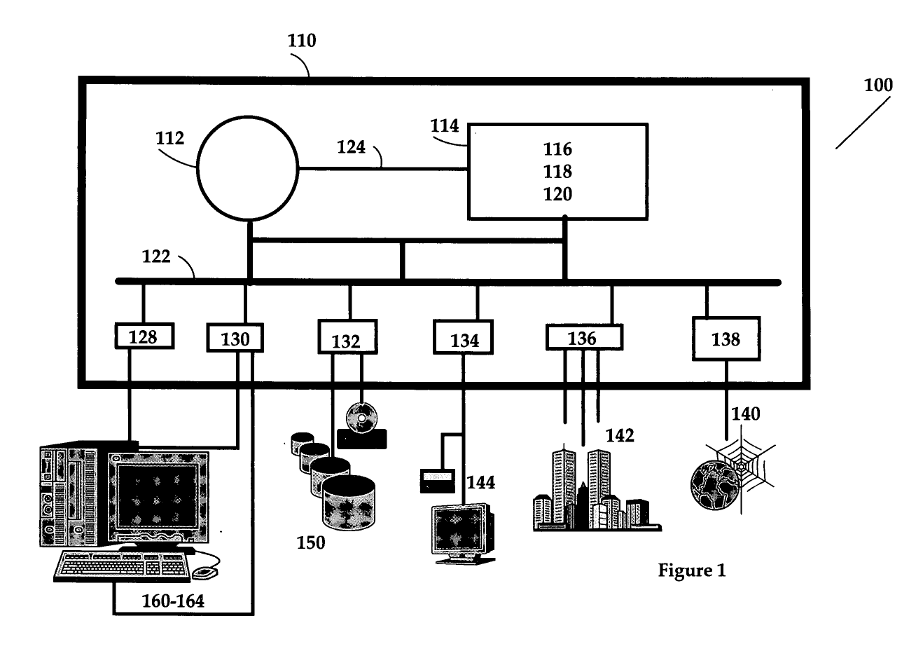

Referring to FIG. 1, a high-level block diagram of a computer network system 100 consistent with an embodiment of the invention is shown. Computer network system 100 may comprise any number of networked computers 110, each of which may have a central processing unit (CPU) 112, main memory 114, and various digital and/or analog interfaces 128-138. The various devices communicate with each other via an internal communications bus 122. CPU 112 is a general-purpose programmable processor, executing instructions stored in memory 114; while a single CPU is shown in FIG. 1, it should be understood that computer systems having multiple CPUs could be used. Communications bus 122 supports transfer of data, commands and other information between different devices, and while shown in simplified form as a single bus, it is typically structured as multiple buses including an internal bus 124 which may connect the CPU 112 directly with memory 114.

Memory 114 is a random-access semiconductor memory for storing data and programs; memory 114 is shown conceptually as a single monolithic entity but it is well known that memory is often arranged in a hierarchy of caches and other memory devices, some or all of which may be integrated into the same semiconductor substrate as the CPU 112. Random access memory (RAM) devices comprising the main storage of computer, as well as any supplemental levels of memory, e.g., cache memories, nonvolatile or backup memories, programmable or flash memories, read-only memories, etc. In addition, memory 114 may be considered to include memory storage physically located elsewhere in computer, e.g., a cache memory in a processor or other storage capacity used as a virtual memory, e.g., as stored on a mass storage device or on another computer coupled to computer via network.

Operating system 116 and applications 118, 120 reside in memory 114. Operating system 116 provides, inter alia, functions such as device interfaces, management of memory pages, management of multiple tasks, etc. as is known in the art. Examples of such operating systems may include LINUX, AIX, UNIX, Windows-based, OS/400, an RTOS, a handheld operating system, etc. On ISERIES and AS/400 machines, OS/400 is the native operating system and object system and IFS is the UNIX object system complemented by the Qshell Unix command shell. These and other various applications, components, programs, objects, modules, etc. may also execute on one or more processors in another computer coupled to computer 110 via a network 140, 142, e.g., in a distributed or client-server computing environment, whereby the processing required to implement the functions of a computer program may be allocated to multiple computers 110 over a network 140, 142.

The invention is equally applicable to any microprocessor device having an operating system in which the microprocessor or processing device is connected across a network to devices having the same or different operating systems. In general, the routines executed to implement the embodiments of the invention, whether implemented as part of an operating system or a specific application, component, program, object, module or sequence of instructions will be referred to herein as computer programs or simply programs. The computer programs typically comprise one or more instructions that are resident at various times in various memory and storage in a device and that, when read and executed by one or more processors in a device, cause that device to perform the steps necessary to execute steps or elements embodying the various aspects of the invention. When used on a client side, MVCML may also be used in ECLIPSE RICH CLIENT applications where MVCML files are distributed with application plugins; in IBM WORKPLACE CLIENt applications where MVCML is delivered as part of an IBM WORKPLACE CLIENT application from an application server to an IBM Workplace Client. Preferably, applications 118, 120 may include a rendering engine, such as a JAVASERVER FACES rendering engine that resides on a web application server. As such, MVCML may also be emitted from JavaServer Faces components on a web application server to an Eclipse Rich Client, or IBM Workplace,Client, i.e., a JAVASERVER FACES renderer would emit MVCML for each JAVASERVER FACES component. MVCML and its rendering engine may also be packaged with stand alone client applications where the user interface definitions are preinstalled and not obtained on demand from a server when the computer is on the server side to interact with the client. As such, MVCML may also be emitted from JAVASERVER FACES components on a web application server to an ECLIPSE RICH CLIENT, or IBM WORKPLACE CLIENT, i.e., a JAVASERVER FACES renderer would emit MVCML for each JAVASERVER FACES component. MVCML and its rendering engine will also be packaged with Standalone SWT applications, as well as STANDALONE SWING applications.

It should be appreciated that computer 110 typically includes suitable analog and/or digital interfaces 128-138 between CPU 112 and the attached components as is known in the art. For instance, computer 110 typically receives a number of inputs and outputs for communicating information externally. For interface with a software developer or operator, computer 110 typically includes one or more software developer input devices 160-164, e.g., a keyboard, a mouse, a trackball, a joystick, a touchpad, and/or a microphone, among others, and a display such as a CRT monitor, an LCD display panel, and/or a speaker, among others. It should be appreciated, however, that some implementations of computer 110, e.g., some server implementations, might not support direct software developer input and output. Terminal interface 134 may support the attachment of single or multiple terminals 144 and may be implemented as one or multiple electronic circuit cards or other units. Data storage 150 preferably comprises one or more rotating magnetic hard disk drive units, although other types of data storage, including a tape or optical driver, could be used. For additional storage, computer 110 may also include one or more mass storage devices 150, e.g., a floppy or other removable disk drive, a hard disk drive, a direct access storage device (DASD), an optical drive e.g., a compact disk (CD) drive, a digital video disk (DVD) drive, etc., and/or a tape drive, among others. One of skill in the art will further anticipate that the interfaces 128-138 may also be wireless.

Furthermore, computer 110 may include an interface 136, 138 with one or more networks 140, 142 to permit the communication of information with other computers 110 coupled to the network(s) 140, 142. Network interface(s) 136, 138 provides a physical and/or wireless connection for transmission of data to and from a network(s) 140, 142. Network(s) 140, 142 may be the Internet, as well as any smaller self-contained network such as an Intranet, a wide area network (WAN), a local area network (LAN), or other internal or external network using, e.g., telephone transmissions lines, satellites, fiber optics, T1 lines, wireless, public cable, etc. and any various available technologies. One of ordinary skill in the art understands that computer system 100 may be connected to more than one network 140, 142 simultaneously. Computer system and remote systems 110 may be desktop or personal computers, workstations, a minicomputer, a midrange computer, a mainframe computer. Any number of computers and other microprocessor devices, such as personal handheld computers, personal digital assistants, wireless telephones, etc., which may not necessarily have full information handling capacity as the large mainframe servers, may also be networked through network(s) 140, 142.

While the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks, e.g., CD-ROMs, DVDs, etc., among others, and transmission type media such as digital and analog communication links. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. The illustrated embodiments are not intended to limit the present invention. Indeed, those skilled in the art will recognize that other alternative hardware and/or software embodiments may be used without departing from the scope of the invention.

The following detailed description of the embodiments of the present invention does not limit the implementation of the invention to any particular computer programming language. The present dialect of XML, MVCML, may be parsed by any computer programming language provided that the operating system provides the facilities that may support the requirements of the present invention. A preferred embodiment is parsed by C or C++ computer programming language, JAVA, or other computer programming languages in conjunction with C/C++. Any limitations presented would be a result of a particular type of operating system, computer programming language, or data processing system and would not be a limitation of the present invention. While the illustrated embodiment is in JAVA and is implemented with JAVASERVER PAGE/FACES technology, the principles herein and the programming are equally applicable to other object-oriented computer languages and other dynamic scripting languages, such as Active Server Pages and Hypertext Preprocessor (PHP). Further the invention is not limited to visual components and HTML, but is preferably implemented in XML and other components compatible and used by XML.

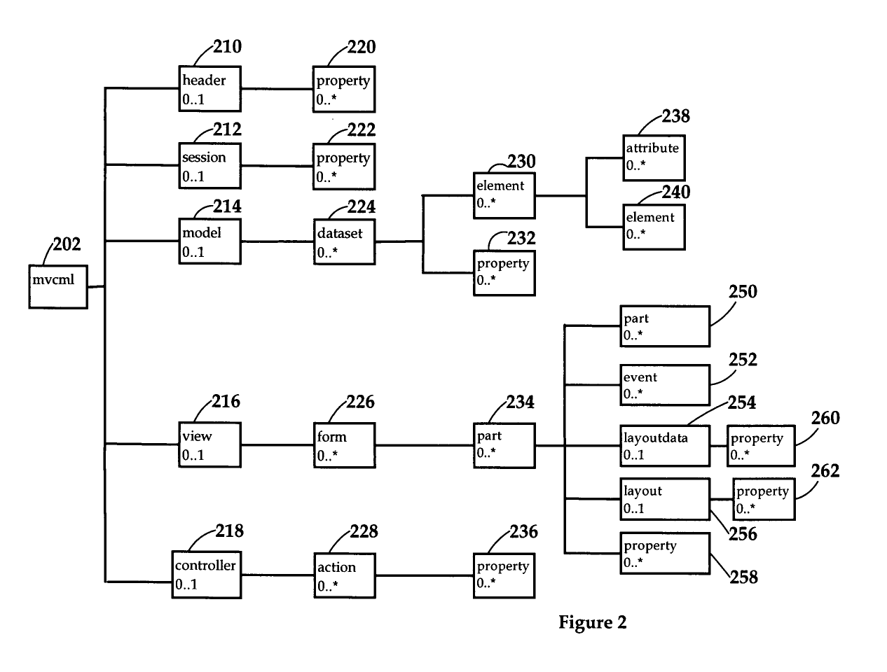

As mentioned in the summary, MVCML is a particularly useful dialect or schema of XML and the schema and its flow are represented in FIG. 2. A MVCML document must contain at least one mvcml element 202, which may have zero or one of any of five basic sections that facilitate its uniqueness and usefulness. One of these sections is a header section 210 with information about a document. Another section is a session section 212 that has session information such as client/server HTTP session synchronization information. MVCML also has a view section 216 that describes a user interface hierarchy, and layout information, a user interface (UI) mechanism that allows for an extensible set of user interface elements, and a UI layout mechanism that allows for an extensible set of user interface layout types, such as grid, pixel, row/column, flow, or card. The MVCML model section 214 describes data, or references to data that are associated with user interface elements. The fifth section, the controller section 218 of MVCML, describes the actions to perform when a user interface event occurs where control logic is specified within or described external to the document.

At the top level, MVCML contains an XML header and an element which is mvcml 202 that has five elements: header, session, model, view, and controller. The mvcml element 202 may have zero or one child header element 210, and zero or one child session element 212, and zero or one child model element 214, and zero or one child controller element 218, and zero or one child view element 216. In any event, the mvcml element 202 must have at least one child element. The header, session, model, view and controller elements may have zero or more child elements as shown in FIG. 2 wherein the numerals under the element represent the possible number of child elements where the notation 0..1 means zero or one, 0..* means zero or more, 1 means one, and 1..* means one or more. Below is an example of MVCML code for the top level.

```
<?xml version=“1.0”?>
<!DOCTYPE mvcml PUBLIC “-//IBM//DTD MVCML 1.0//EN”
“MVCML_1_0.dtd”>
<mvcml> ... </mvcml>
<mvcml> 202
    <header> 210
    ...
    </header>
    <session> 212
    ...
    </session>
    <model> 214
    ...
    </model>
    <view> 216
    ...
    </view>
    <controller> 218
    ...
    </controller>
</mvcml>
```

The header section 210 contains descriptive information about the document, such as the author, date, description of the document, modification date, metadata, etc. The header section 210 may have any number of property elements 220 that specify a property of the header. The property element allows for implementers to specify any document properties without requiring changes to the MVCML schema. Each property may have an optional value between the start and end tags of the XML element, such as <property name=“color”>black</property>, where “black” is the optional value. Advantageously, the header section allows search engines to search for particular document properties. Below is an example of code for the header section 210.

<header>
<property name=“author”>authorsName</property>
</header>

The session section 212 may specify information about an HTTP session, and any information that a web application server needs to convey to a client, such as a command to obtain another document, or to close the application. For standalone, or client/server applications where there is no web application server, an application session identifier can be specified. The session section 212 may also contain the synchronization information between the client and server, such as, while a session between two data processing devices is active, the session may be disconnected for some reason such as a power failure. The session section can be used to re-establish the session so that the person using the application is able to resume processing at the point where the session terminated. The session section 212 may also have any number of child elements that specify a property of the session. Each property element 222 allows for applications to supply any session property without requiring changes to the MVCML schema. Below is an example of MVCML code for a session section 212.

```
<session id=“sessionID”>
      <property
      name=“displayAdditionalForm”>welcomeDialog</property>
</session>
```

The view section 216 specifies the viewable user interface forms and contains the user interface hierarchy, the user interface layout and layout data information, references to data and data references, and references to controller actions. The view section 216 may have at least one child XML element—the form 226. The form element 226 specifies a form where each form has a unique form identifier within the document. The part element 234 specifies the type of widget and has an optional part identifier unique to the form. The part element 234 allows vendors to supply additional part types without requiring changes to the MVCML schema. The part element 234 may also have its own child XML elements: part [0..*] 250, property [0..*] 258, event [0..*] 254, layout [0..1] 256, and layoutdata [0..1] 254. An event element 252 specifies an event name of an event that occurs on a part such as ‘select’ or ‘lostfocus’, and a reference to an action identifier in the controller section 218. The event element 252 links the user interface part properties to control logic. The event element 252 further allows for vendors to supply any event type with their part types without requiring changes to the MVCML schema. The layout element 256 specifies how a part physically arranges its child parts on the user interface and may have property and property child elements. Types of layouts may include pixel, grid, row/column and stack. The layout element 256 also allows for vendors to supply new layout types without requiring changes to the MVCML schema. The layoutdata child element 254 specifies how a part is to be laid out within its parent part and may have any number of property and property child elements. If a layout data type is specified, it must correspond to the layout type of its parent element. For instance a griddata type would correspond to a parent layout type of grid. Similarly, a pixeldata type would correspond to a parent layout type of pixel. The layoutdata element 254 allows for vendors to supply new layout data types without requiring changes to the MVCML schema. The property element 258 specifies a property of a part. The property element 258 allows part providers to supply any part, layout and layout data properties to their part types without requiring changes to the MVCML schema. The property element 260 specifies a property of a layout data. The property element 262 specifies a data set identifier that references a dataset 224 in the model section 214 and refers to data contained within the MVCML document or to data stored external to the MVCML document, i.e., the property element links the user interface part properties to the model data. The value can be a path to particular data within the dataset. Below is an example of MVCML code of a View section.

```
  <view>
    <form>
      <part type=“frameWindow”>
        <layout type=“grid”>
          <property name=“columns”>1</property>
          <property name=“marginX”>8</property>
          <property name=“marginY”>4</property>
        /layout>
        <property name=“title”>Frame Window Title</property>
        <part type=“canvas” id=“canvas1”>
          <layoutdata type=“griddata”>
            <property name=“alignmentX”>fill</property>
            <property name=“alignmentY”>center</property>
          </layoutdata>
          <layout type=“pixel” />
        <part type=“button” id=“button1”>
          <property name=“text”>Press this button</property>
          <layoutdata type=“pixeldata”>
            <property name=“originX”>10</property>
            <property name=“originY”>10</property>
            <property name=“extentX”>50</property>
            <property name=“extentY”>28</property>
          </layoutdata>
          <event name=“press”actionid=“actionID1” />
        </part>
        <part type=“entryfield” id=“entryfield1”>
          <property name=“text” datasetid=“datasetID1”
>optionalPathWithinDataset</property>
          <layoutdata type=“pixeldata”>
            <property name=“originX”>80</property>
            <property name=“originY”>10</property>
            <property name=“extentX”>200</property>
            <property name=“extentY”>28</property>
          </layoutdata>
        </part>
        <part type=“listbox” id=“listbox1”>
            <property name = “items”datasetid = “datasetID2” >
optionalPathWithinDataset</property>
            <layoutdata type=“pixeldata”>
              <property name=“pixeldata” datasetid= “datasetID4” />
            </layoutdata>
            <event name=“select”actionid=“actionID2” />
          </part>
        </part>
      </part>
    </form>
  </view>
```

The model section 214 contains data that may be explicitly defined within the document using elements and attributes, or the data may be explicitly defined within the document using an external XML format that is embedded within the document. Alternatively, the model section 214 may reference externally defined data. The model section 214 may have any number of dataset 224 child elements that contains explicitly embedded data elements, or a reference to an external data source. The dataset element 224 may have a type and an identifier, and may also have any number of element 230 and/or property 232 child elements. The element 230 of the dataset 224 refers to a data element within an explicitly defined hierarchy of data elements in a data set. Each element 230 may or may not have a name and/or value and/or an attribute child element. The attribute child element 238 may also have a name and an optional value. The property element 232 of the dataset 224 may have a name and a value that specifies a property of a dataset. The property element allows for implementers to specify any dataset properties without requiring changes to the MVCML schema. Below is an example of MVCML code for the model section.

```
<model>
  <!-- Explicitly defined data for a one dimensional list of items -->
  <dataset id=“datasetID1” type=“elements”>
      <element name=“elementName1”>item1</element>
      <element name=“elementName2”>item2</element>
      <element name=“elementName3”>item3</element>
      <element name=“elementName4”>item4</element>
  </dataset>
  !-- Explicitly defined data with hierarchical structure -->
  <dataset id=“datasetID2” type=“elements”>
      <element name=“elementName1”>
        <attribute name=“attributeName1”>value1a</attribute>
      <element name=“elementName11”>value11
        <attribute name=“attributeName2”>value2a</attribute>
      </element>
      <element name=“elementName12”>value12</element>
      </element>
    </dataset>
  <!-- Reference to external data -->
  <dataset id=“datasetID3” type=“reference”>
        <property name=“uri”>uriToDataset</property>
        <property name=“path”>pathWithinDataset</property>
  </dataset>
  <!-- Embedded data using another XML format such as XMI -->
  <dataset id=“datasetID4” type=“xmi”>
      <xsd:complextype name=“XMI”>
        ...
      </xsd:complextype>
  </dataset>
  <!-- Reusable properties, for example, to specify commonly used
  layoutdata -->
  <dataset id=“datasetID5” type=“property”>
        <property name=“alignmentX”>fill</property>
        <property name=“alignmentY”>center</property>
        <property name=“excessX”>true</property>
        <property name=“indentX”>17</property>
  </dataset>
</model>
```

The controller section 218 contains information about specific actions to perform, and details about the action. Accordingly, the controller section 218 has any number of action child elements 228, each of which may have any number of property child elements 236. The action element 228 refers to an action to be processed, and each action element 228 may have an identifier that is unique within the controller section 218 and a type attribute that specifies the type of action to be taken. For example in the code that was bolded and double-underlined in the discussion of the view section, see the event name=“press” actionid=“actionID1”/>; the identfier actionID1 refers to the action in the controller section, (also bold and double-underline below) of the code that has the same identifier, i.e., action id=“actionID1” type=“submit”. The property element 236 of the action element 228 may have a name and a value that specifies a detail about the action based upon the action type. The property element allows for implementers to specify any action properties without requiring changes to the MVCML schema. Below is an example of MVCML code for the controller section.

```
<controller>
  <!-- Submit the form to a web application server -->
  <action id=“actionID1” type=“submit”>
    <property
    name=“actionhandler”>actionHandlerSpecification</property>
  </action>
  <!-- Handle the action locally -->
  <action id=“actionID2” type=“call”>
    <property name=“method”>classMethodSpecification</property>
  </action>
  <!-- Set a target attribute value to the value of a source attribute -->
  <action id=“actionID3” type=“attributelink”>
    <property name=“source”>sourcePartID</property>
    <property name=“sourceattribute”>sourceAttributeName</property>
    <property name=“target”>targetPartID</property>
    <property name=“targetattribute”>targetAttributeName</property>
  </action>
  <!-- Process control logic specified with a scripting language -->
  <action id=“actionID4” type=“script”>
    <property name=“language”>PHP</property>
    <property name=“script”>
      <!-- Place script here -->
    </property>
  </action>
</controller>
```

Below is an example of code for the MVCML schema.

```
<?xml version=“1.0” encoding=“UTF-8”?>
<xsd:schema xmlns:xsd=“http:/ /www.w3.org/2001/XMLSchema”>
  <xsd:element name=“mvcml”>
    <xsd:complexType>
      <xsd:sequence>
        <xsd:element minOccurs=“0” maxOccurs=“1” ref=“header”/>
        <xsd:element minOccurs=“0” maxOccurs=“1” ref=“session”/>
        <xsd:element minOccurs=“0” maxOccurs=“1” ref=“model”/>
        <xsd:element minOccurs=“0” maxOccurs=“1” ref=“view”/>
        <xsd:element minOccurs=“0” maxOccurs=“1” ref=“controller”/>
      </xsd:sequence>
    </xsd:complexType>
  </xsd:element>
  <xsd:element name=“header”>
    <xsd:complexType>
      <xsd:sequence>
        <xsd:element minOccurs=“0” maxOccurs=“unbounded” ref=“property”/>
      </xsd:sequence>
    </xsd:complexType>
  </xsd:element>
  <xsd:element name=“session”>
    <xsd:complexType>
      <xsd:sequence>
          <xsd:element minOccurs=“0” maxOccurs=“unbounded” ref=“property”/>
      </xsd:sequence>
    </xsd:complexType>
  </xsd:element>
  <xsd:element name=“model”>
    <xsd:complexType>
      <xsd:sequence>
        <xsd:element minOccurs=“0” maxOccurs=“unbounded” ref=“dataset”/>
      </xsd:sequence>
    </xsd:complexType>
  </xsd:element>
  <xsd:element name=“dataset”>
    <xsd:complexType>
      <xsd:sequence>
        <xsd:choice>
          <xsd:element maxOccurs=“unbounded” minOccurs=“0” ref=“element”/>
          <xsd:element maxOccurs=“unbounded” minOccurs=“0” ref=“property”/>
        </xsd:choice>
      </xsd:sequence>
      <xsd:attribute name=“type” type=“xsd:string”/>
      <xsd:attribute name=“id” type=“xsd:string”/>
    </xsd:complexType>
  </xsd:element>
  <xsd:element name=“element”>
    <xsd:complexType mixed=“true”>
      <xsd:sequence>
        <xsd:element maxOccurs=“unbounded” minOccurs=“0” ref=“attribute”/>
        <xsd:element maxOccurs=“unbounded” minOccurs=“0” ref=“element”/>
      </xsd:sequence>
      <xsd:attribute name=“name” type=“xsd:string”/>
    </xsd:complexType>
  </xsd:element>
  <xsd:element name=“attribute”>
    <xsd:complexType mixed=“true”>
      <xsd:attribute name=“name” type=“xsd:string”/>
    </xsd:complexType>
  </xsd:element>
  <xsd:element name=“view”>
    <xsd:complexType>
      <xsd:sequence>
        <xsd:element maxOccurs=“unbounded” minOccurs=“0” ref=“form”/>
      </xsd:sequence>
    </xsd:complexType>
  </xsd:element>
  <xsd:element name=“form”>
    <xsd:complexType>
      <xsd:sequence>
        <xsd:element maxOccurs=“unbounded” minOccurs=“0” ref=“part”/>
      </xsd:sequence>
      <xsd:attribute name=“id” type=“xsd:string”/>
    </xsd:complexType>
  </xsd:element>
  <xsd:element name=“part”>
    <xsd:complexType>
      <xsd:choice maxOccurs=“unbounded” minOccurs=“0”>
        <xsd:element maxOccurs=“unbounded” minOccurs=“0” ref=“part”/>
        <xsd:element maxOccurs=“unbounded” minOccurs=“0” ref=“event”/>
        <xsd:element maxOccurs=“1” minOccurs=“0” ref=“layoutdata”/>
        <xsd:element maxOccurs=“1” minOccurs=“0” ref=“layout”/>
        <xsd:element maxOccurs=“unbounded” minOccurs=“0” ref=“property”/>
      </xsd:choice>
      <xsd:attribute name=“type” type=“xsd:string”/>
      <xsd:attribute name=“id” type=“xsd:string”/>
    </xsd:complexType>
  </xsd:element>
  <xsd:element name=“event”>
    <xsd:complexType>
      <xsd:attribute name=“actionid” type=“xsd:string”/>
      <xsd:attribute name=“name” type=“xsd:string”/>
    </xsd:complexType>
  </xsd:element>
  <xsd:element name=“layout”>
    <xsd:complexType>
      <xsd:sequence>
        <xsd:element maxOccurs=“unbounded” minOccurs=“0” ref=“property”/>
      </xsd:sequence>
      <xsd:attribute name=“type” type=“xsd:string”/>
    </xsd:complexType>
  </xsd:element>
  <xsd:element name=“layoutdata”>
    <xsd:complexType>
      <xsd:sequence>
        <xsd:element maxOccurs=“unbounded” minOccurs=“0” ref=“property”/>
      </xsd:sequence>
      <xsd:attribute name=“type” type=“xsd:string”/>
    </xsd:complexType>
  </xsd:element>
  <xsd:element name=“controller”>
    <xsd:complexType>
      <xsd:sequence>
        <xsd:element maxOccurs=“unbounded” minOccurs=“0” ref=“action”/>
      </xsd:sequence>
    </xsd:complexType>
  </xsd:element>
  <xsd:element name=“action”>
    <xsd:complexType>
      <xsd:sequence>
        <xsd:element minOccurs=“0” maxOccurs=“unbounded” ref=“property”/>
      </xsd:sequence>
      <xsd:attribute name=“type” type=“xsd:string”/>
      <xsd:attribute name=“id” type=“xsd:string”/>
    </xsd:complexType>
  </xsd:element>
  <xsd:element name=“property”>
    <xsd:complexType mixed=“true”>
      <xsd:attribute name=“datasetid” type=“xsd:string”/>
      <xsd:attribute name=“name” type=“xsd:string”/>
    </xsd:complexType>
  </xsd:element>
</xsd:schema>
```

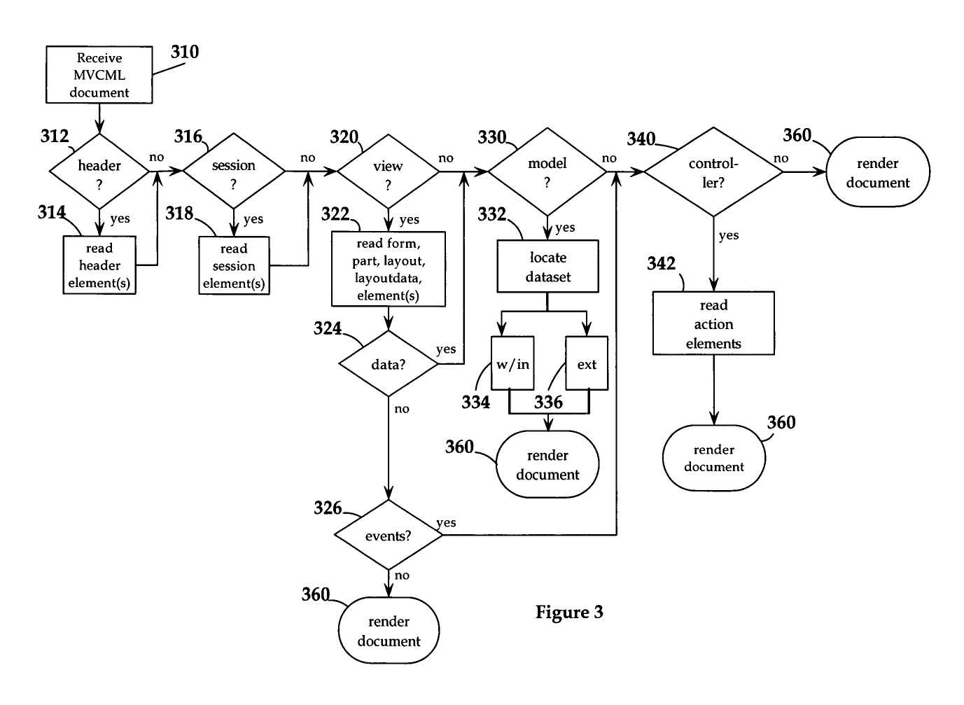

FIG. 3 describes the process by which a data processing device can render a MVCML document that is received. In step 310, a MVCML document is received either from an application installed on the data processing device or from a server across a network. The process may begin at step 312 by first determining if there is a header section (210 in FIG. 2). If so, then the properties or elements of the header section are read as in step 314. In any event, the process also determines if there is a session section (212 in FIG. 2). Similarly, in step 318, the process will read the properties and elements of the session section. If there is a view section (216 of FIG. 2), as in step 320, then the process reads the forms, parts, events, layoutdata, layout, properties, and elements of the view section. If there are data to be rendered or displayed in the view, as in step 324, the process may go to step 330 at the model section (214 in FIG. 2) to retrieve the data. If there are no data, the process then checks to determine if there are any events associated with the particular view or form, as in step 326. If there are no data nor any events, the document can be rendered on the data processing device as in step 360.

If there are data associated with the view section, as in step 324, the process loops to step 330 to determine that a model section (214 of FIG. 2) may exist. If so, then the process determines the location of the dataset at step 332. The corresponding dataset may either be located within the document as in step 334 or may be located external to document. Regardless of where the data is located, it is retrieved and the document is rendered as in step 360.

Actions are initiated when a user interacting with the user interface or an application interacting with an application program interface initiates a user interface event, such as a button press. Then the action is performed, whereby another MVCML document may be loaded, parsed and rendered. So, if there any events associated with the document, as in step 326, the process will connect to the controller section (218 in FIG. 2) at step 340 to read any action elements, as shown in step 342. As a result of the various actions and responsive events, which may either be linked to the document from within the document or from an external source, the same or another MVCML document may be loaded, parsed, and rendered as in step 360.

Thus, MVCML is platform and device independent; and can be represented with JAVA SERVER FACES tags and JAVASERVER FACES components. MVCML can be rendered with a user interface rendering engine on a client device. MVCML has a small number of XML elements that can be efficiently parsed on devices with small footprints. Thus, what has been described as MVCML is a schema or document type declaration that describes a document. The document, in turn, enables a web application server to communicate form information to a client platform. MVCML further contains sufficient information for describing a user interface that can be rendered to a platform's user interface. MVCML has a minimum number of element and attribute types and is easier to learn, remember and hand code than other schemas. Information used by MVCML includes session information, a user interface definition, entities associated with the user interface such as data and data references, control logic and control logic references. The information is organized in sections, where each section allows for an extensible set of information types. MVCML can also be used when a user interface rendering engine is installed on a client within a client/server environment without a web application server.

It will be appreciated that variations of some elements are possible to adapt the invention for specific conditions or functions. The concepts of the present invention can be further extended to a variety of other applications that are clearly within the scope of this invention. Having thus described the present invention with respect to preferred embodiments as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

What is claimed is:

1. A method of rendering a computer document on a client, comprising reading a mvcml element of a Model View Controller Machine Language (MVCML) schema.

2. The method of claim 1, further comprising reading a header section of the mvcml element, the header section having at least one header property of the document to be displayed on a client.

3. The method of claim 2, further comprising reading one or more of the following header properties from the header section:
date of creation of the document;
date(s) of modification of the document;
author of the document, name of the document;
description of the document.

4. The method of claim 2, further comprising extending the header section whereby additional header properties can be added to the header section, without requiring changes to other sections of the MVCML schema or other header properties.

5. The method of claim 1, further comprising reading a session section of the mvcml element, the session section having at least one session property concerning at least one application.

6. The method of claim 5, further comprising reading one or more of the following session properties from the session section:
(a) connection information between a server having the document and a client displaying the document;
(b) synchronization;
(c) time and date of session;
(d) type of connection, if any, between a server having the document and the client displaying the document;
(e) number of bytes transmitted/received;
(f) one or more forms to be opened or closed.

7. The method of claim 5, further comprising extending the session section whereby additional session properties can be added, without requiring changes to other sections of the schema or other session properties.

8. The method of claim 1, further comprising reading a view section of the mvcml element schema, the view section having at least one view property relating to display of the document on a client.

9. The method of claim 8, further comprising reading one or more of the following view properties:
(a) a user interface hierarchy;
(b) a user interface layout;
(c) layout data information;
(d) references to data;
(e) references to controller actions.

10. The method of claim 9, further comprising displaying a user interface relating to the document on the client.

11. The method of claim 8, further comprising reading at least one part of a form to be rendered on the document, the at least one part comprising one of the following:
(a) an additional part;
(b) an event;
(c) layout data;
(d) layout;
(e) a view property.

12. The method of claim 8, further comprising extending the view section whereby additional view properties can be added, without requiring changes to other sections of the schema or other view properties.

13. The method of claim 11, further comprising extending the layoutdata whereby one or more layoutdata properties can be added, without requiring changes to other sections of the schema or other layoutdata properties.

14. The method of claim 11, further comprising extending the layout whereby additional layout properties can be added, without requiring changes to other sections of the schema or other layout properties.

15. The method of claim 1, further comprising reading a model section of the mvcml element, the model section having at least one data element property that determines the data and the location of the data used in the document to be rendered on the client.

16. The method of claim 15, further comprising reading an attribute of the at least one data element property.

17. The method of claim 15, further comprising extending the model section whereby additional data element properties can be added, without requiring changes to other sections of the schema or other data element properties.

18. The method of claim 1, further comprising reading a controller section of the mvcml element, the controller section having at least action property relating to action events to be performed in response to events initiated by the user and/or application using a user interface specified by the document.

19. The method of claim 18, further comprising extending the action properties of the controller section whereby additional action properties can be added, without requiring changes to other sections of the schema or other action properties.

20. The method of claim 1, wherein the computer document is stored on a server and rendered on a client.

21. The method of claim 1, wherein the document is stored on a client and rendered on the client.

22. The method of claim 15, further comprising locating the data on a server or another computer connected to the client.

23. A data communication system including a transmitting data processing device which performs data transmission via a communication network and a receiving data processing device which receives the data transmitted from the transmitting data processing device via the communication network, said transmitting data processing device comprising: a transmitting portion which transmits a MVCML document, and said receiving data processing device comprising: a receiving portion which receives the MVCML document transmitted from the transmitting data processing device; and renders the MVCML document on a user interface of the receiving data processing device.

24. A computer program product in a computer-readable medium for encoding a MVCML document in a data processing system.

25. The computer program product in a computer-readable medium, of claim 24, further comprising a plurality of extensible sections having at least one property per section used in rendering the MVCML document, the extensible sections being extended without affecting any of a plurality of other properties of the MVCML document.

26. A computer program product stored in a computer-readable medium, for decoding a MVCML document in a data processing device, comprising: instructions for reading a MVCML header property of the MVCML document; instructions for reading a MVCML session property of the MVCML document; instructions for reading a MVCML view section of the MVCML document; instructions for reading a MVCML model property of the MVCML document; instructions to obtain data referenced by the MVCML model section of the MVCML document; instructions for reading a MVCML controller section of the MVCML document, instructions to render the MVCML document on the data processing device, and instruction to respond to any actions of a user in response to rendering the MVCML document on the data processing device.
